(19) United States
(12) Patent Application Publication
(10) Pub. No.: US 2026/0175416 A1
(43) Pub. Date: Jun. 25, 2026

(54) ROBOT ACTION GENERATION METHOD AND SYSTEM COMBINING GENERAL AND SPECIALIZED MODELS

(71) Applicant: TONGJI UNIVERSITY, Shanghai (CN)

(72) Inventors: Bin He, Shanghai (CN); Zhipeng Wang, Shanghai (CN); Feida Gu, Shanghai (CN); Yanmin Zhou, Shanghai (CN); Bin Cheng, Shanghai (CN); Shuo Jiang, Shanghai (CN)

(73) Assignee: TONGJI UNIVERSITY, Shanghai (CN)

(21) Appl. No.: 19/394,886

(22) Filed: Nov. 20, 2025

(30) Foreign Application Priority Data
Dec. 20, 2024 (CN) 202411892699.7

(51) Int. Cl. B25J 9/16; G06T 5/70; G06T 7/50

(52) U.S. Cl. CPC B25J 9/163; B25J 9/161; G06T 5/70; G06T 7/50; G06T 2207/10028; G06T 2207/20081; G06T 2207/20084; G06T 2207/20221

(57) ABSTRACT

The present invention relates to a robot action generation method and system combining general and specialized models, where the method includes: constructing the general model and the specialized model, pre-training the general model, performing parameter fine-tuning on a pre-trained general model, and training the specialized model based on a fine-tuned general model; acquiring a task instruction and real-time visual information, inputting the task instruction and real-time visual information into the fine-tuned general model, and outputting an action sequence and a task latent feature; and acquiring real-time point cloud perception data, and inputting the real-time point cloud perception data, together with the action sequence and the task latent feature, into a trained specialized model, and outputting continuous robot actions. Compared with the prior art, the present invention improves the speed of robot action generation and enhances the generalization of robot action generation.

### CROSS-REFERENCE TO RELATED APPLICATION

This application claims the priority benefit of China application serial no. 202411892699.7, filed on Dec. 20, 2024. The entirety of the above-mentioned patent application is hereby incorporated by reference herein and made a part of this specification.

### BACKGROUND

### Technical Field

The present invention relates to the technical field of robot control, and in particular to a robot action generation method and system combining general and specialized models.

### Description of Related Art

Achieving robots with multi-task operation and self-adaptation capabilities has always been a core goal in the field of robotics. Traditional robot learning methods typically involve learning policies through datasets specifying robots and specific tasks, and these operational policies are referred to as specialized models. Specialized models exhibit high precision in specific scenarios and tasks, but often have limited generalization ability. With the increasing application of robots in open-ended and multi-task scenarios, the demand for multi-task robots has surged.

In response to the demand for multi-task robots, general robot strategies have begun to develop, such as RT-2 and OpenVLA. These strategies attempt to apply Internet knowledge to robot control and use a wide range of heterogeneous datasets to enhance the cross-domain generality of robots. General policies integrate a large amount of cross-ontology data with pre-trained large language models, enabling functions such as common sense reasoning and instruction tracking in robot policy learning. General policies excel at knowledge transfer and generalization across different scenarios, but they still have some limitations: 1) They cannot be directly deployed to new applications or environments without fine-tuning. Compared with specialized policies, the fine-tuning process requires more data and training. 2) Although general policies are good at decision-making, their large model characteristics lead to extremely high inference latency. This critical bottleneck renders them unsuitable for fine control in dynamic environments. Currently, model lightweighting is adopted to address the above shortcomings, but this will result in a significant decline in model performance.

Therefore, providing a robot action generation method that can both meet the generalization of general models and the high performance of specialized models is a technical problem that needs to be solved.

### SUMMARY

An objective of the present invention is to overcome the defects of the above prior art and provide a robot action generation method and system combining general and specialized models. By effectively combining the general model and the specialized model, the general model is used to process complex multimodal data, and point cloud data is used as the input of the specialized model while the output of the general model is used as the diffusion denoising condition, thus retaining both the generalization of the general model and the accuracy of the specialized model.

The objective of the present invention can be achieved through the following technical solutions.

According to a first aspect of the present invention, a robot action generation method combining general and specialized models is provided, including:
constructing the general model and the specialized model, pre-training the general model, performing parameter fine-tuning on a pre-trained general model, and training the specialized model based on a fine-tuned general model;
acquiring a task instruction and real-time visual information, inputting the task instruction and real-time visual information into the fine-tuned general model, and outputting an action sequence and a task latent feature; and
acquiring real-time point cloud perception data, and inputting the real-time point cloud perception data, together with the action sequence and the task latent feature, into a trained specialized model, and outputting continuous robot actions.

As a preferred technical solution, the general model is constructed based on a vision-language large model.

As a preferred technical solution, the specialized model is constructed based on a lightweight and scalable diffusion model.

As a preferred technical solution, the pre-training of the general model includes:
acquiring robot operation data, where the robot operation data includes a language instruction, image data, and robot action data;
extracting a language feature and a visual feature using the general model based on the language instruction and the image data, and aligning the language feature and the visual feature; and
iteratively performing the following steps until the pre-training is completed:
inputting an aligned language feature and visual feature into the general model, outputting a first discretized action, and performing decoding processing on the first discretized action; and
calculating a first loss based on a decoded first discretized action and the robot action data, and performing backpropagation, calculating a first gradient, and updating parameters of the general model based on the first gradient.

As a preferred technical solution, a method for fine-tuning the general model includes:
acquiring robot operation data under a specific task, and acquiring parameters of the pre-trained general model as initial parameters;
determining a fine-tuning range for parameters related to visual feature extraction, language feature extraction, and action decoding in the initial parameters, and freezing other parameters in the initial parameters;
inputting the robot operation data under the specific task into the general model, and outputting a second discretized action; and
calculating a second loss based on the second discretized action and robot action data in the robot operation data under the specific task, and performing backpropagation, calculating a second gradient, and updating parameters of the general model based on the second gradient.

As a preferred technical solution, the training of the specialized model includes:
acquiring a point cloud dataset and robot operation data at a corresponding time, where the point cloud dataset includes point cloud data, robot state proprioception data, and robot action data;
outputting an action sequence and a task latent feature using the fine-tuned general model based on the robot operation data at the corresponding time; and
training the specialized model based on the point cloud dataset, the action sequence, and the task latent feature, calculating a loss in a training process, and performing backpropagation, calculating a gradient, and updating parameters of the specialized model based on the gradient.

As a preferred technical solution, the general model and the specialized model collaborate asynchronously, and a method for asynchronous collaboration is:
acquiring a task instruction and real-time visual information at a current time t₁, and outputting an action sequence and a task latent feature at the time t₁ using the general model; and
acquiring real-time point cloud perception data from the time t₁ to a time tₙ, and outputting continuous actions from the time t₁ to the time tₙ using the specialized model based on the action sequence and the task latent feature at the time t₁.

As a preferred technical solution, a method for the outputting an action sequence and a task latent feature at the time t₁ is:
extracting a visual feature using the general model based on the visual information at the time t₁, and extracting a language feature using the general model based on the task instruction at the time t₁;
projecting the visual feature and the language feature into a unified latent space to generate a task latent feature at the time t₁; and
generating a discretized action sequence according to a time step using the general model based on the visual feature and the language feature, with an expression thereof:

$${a}_{{t}_{1}} = {g}_{ϕ} ( {a}_{< {t}_{1}} , c ) ,$$

where αₜ_{₁} represents the action sequence at the time t₁, act represents an action sequence before the time t₁, c represents the visual feature and the language feature, and g_{φ}(⋅) represents processing by the general model.

As a preferred technical solution, a method for the outputting continuous actions from the time t₁ to the time tₙ includes:
extracting a real-time point cloud perception feature based on the real-time point cloud perception data from the time t₁ to the time tₙ; and
aligning and fusing a real-time point cloud perception feature at each time with the action sequence and the task latent feature at the time t₁, respectively, and generating an action at the corresponding time using a diffusion denoising mechanism, with an expression thereof:

$${a}_{{t}_{i}} = {π}_{θ} ( {a}_{{t}_{i}} + ϵ , {c}_{{t}_{i}}^{′} ) ,$$

where αₜ_{ᵢ} represents an action at the time tᵢ and i∈[1, n], ϵ represents Gaussian noise, and cₜ_{ᵢ} represents an alignment and fusion result of a real-time point cloud perception feature at the time tᵢ and the action sequence and the task latent feature at the time t₁.

According to a second aspect of the present invention, a robot action generation system combining general and specialized models for implementing the above method is provided.

Compared with the prior art, according to the present invention, a general model is utilized to process multimodal data composed of vision, language, etc. The output of the general model is taken as the diffusion denoising condition for the specialized model, and combined with point cloud data that can provide better spatial information to output continuous actions of the robot, while retaining the generalization of the general model and the accuracy of the specialized model. In addition, in the present invention, asynchronous collaboration is maintained between the general model and the specialized model. That is, the general model performs inference once at the current moment, and the specialized model infers actions including the current moment and multiple subsequent moments based on the inference result of the general model at the current moment. This not only reduces the resource consumption of the general model but also ensures the accuracy of the generated actions.

### BRIEF DESCRIPTION OF THE DRAWINGS

FIG. 1 is a flow chart of a method according to the present invention.

FIG. 2 is a hardware architecture diagram of a system according to the present invention.

### DESCRIPTION OF THE EMBODIMENTS

The technical solutions in the embodiments of the present invention are clearly and completely described below with reference to the accompanying drawings in the embodiments of the present invention. Apparently, the described embodiments are merely some rather than all of the embodiments of the present invention. Based on the embodiments of the present invention, all other embodiments obtained by those of ordinary skill in the art without creative efforts shall fall within the scope of protection of the present invention.

Unless otherwise defined, the technical terms or scientific terms used in this application shall have the ordinary meanings understood by those of ordinary skill in the technical field to which this application pertains. The terms such as “a,” “an,” “one,” “the,” and the like in this application do not indicate numerical limitations and may refer to the singular or plural. The terms “include,” “comprise,” “have,” and any variations thereof used in this application are intended to cover non-exclusive inclusion; for example, a process, method, system, product, or device that includes a series of steps or modules (units) is not limited to the listed steps or units, but may further include unlisted steps or units, or may further include other steps or units inherent to these processes, methods, products, or devices. The terms such as “connect,” “link,” and “couple” used in this application are not limited to physical or mechanical connections, but may include electrical connections, whether direct or indirect. The term “plurality” used in this application refers to two or more. “And/or” describes the relational association between related objects, indicating that three relationships may exist. For example, “A and/or B” may mean three scenarios: A exists alone, both A and B exist simultaneously, or B exists alone. The character “/” generally indicates that the associated objects before and after it have an “or” relationship. The terms such as “first,” “second,” and “third” used in this application merely distinguish similar objects and do not represent a specific ordering of the objects.

This embodiment combines the generalization of the multimodal general model and the efficient performance of the specialized model, improving the generalization and inference speed of the robot action generation system. The specialized model uses point cloud data as input, and compared with RGB image data, point cloud data provides better spatial information, which helps to enhance the robot's operational capability.

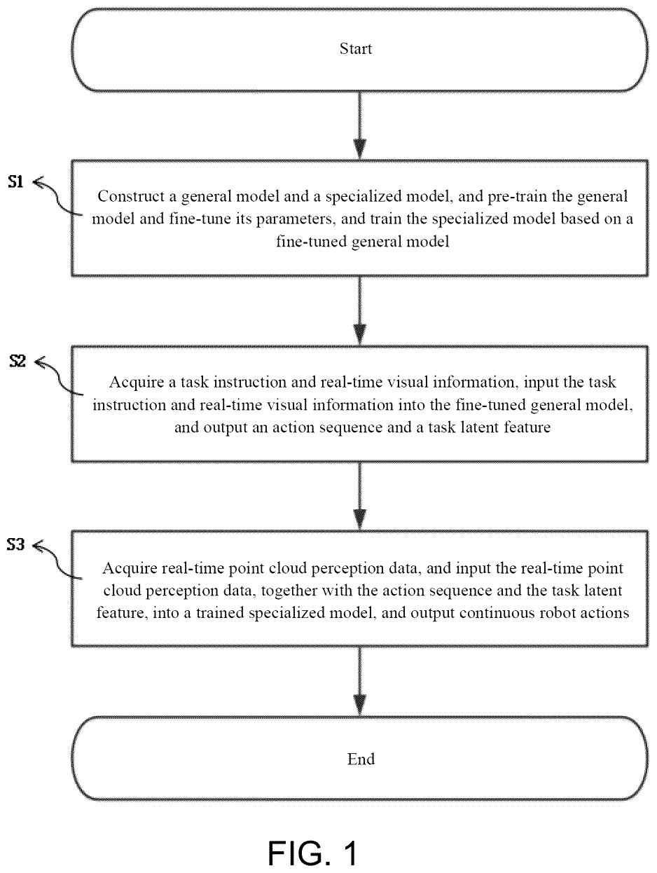

Specifically, a flow of the method is as shown in FIG. 1, including S1-S3.
S1. Model construction.
S11. Based on a vision-language large model such as OpenVLA, construct an autoregressive vision-language action model with approximately 7B parameters as a general model. Specifically, the general model includes a visual encoder, a large model (LLaMA-2) module, and an action generation module, where the action generation module includes an action decoder.
S12. Pre-training of the general model.
S121. Acquire robot operation data, including a language instruction, an RGB image, and robot action data.
S122. Extract a visual feature based on the RGB image using a visual encoder (DINOv2 and ViT), extract a language feature based on a language instruction using a large language model, and map the visual feature to a latent space consistent with the language feature through a multilayer perceptron for feature alignment.
S123. Input an aligned language feature and visual feature into the action generation module to output a first discretized action, and perform decoding processing on the first discretized action, and map an action range to a uniform distribution of [−1, 1] to ensure that the general model has a clear physical constraint when generating an action.
S124. Calculate a first loss based on a decoded first discretized action and the robot action data, and perform backpropagation, calculate a first gradient, and update parameters of the general model using an AdamW optimizer based on the first gradient.

A calculation expression for the first loss is:

$${L}_{gen} = {𝔼}_{p , {a}_{< i}} [ - {\sum }_{i = 1}^{{N}_{a}} log P ( {a}_{i} \vert p , {a}_{< i} ) ] ,$$

where p is an input language prompt, α_{<i} is an action sequence generated before a step i, and N_{α} is a length of the action sequence.

Iteratively perform steps S123 to S124 until the pre-training is completed.
S13. Fine-tuning of the general model.
S131. Acquire robot operation data under a specific task, such as robot operation data generated during clothes folding, and acquire parameters of a pre-trained general model as initial parameters to retain general knowledge learned in a pre-training process.
S132. Determine a fine-tuning range for parameters related to visual feature extraction, language feature extraction, and action decoding in the initial parameters, and freeze other parameters in the initial parameters.
S133. Input the robot operation data under the specific task into the general model, and output a second discretized action.
S134. Calculate a second loss based on the second discretized action and robot action data in the robot operation data under the specific task, and a calculation expression thereof is consistent with that in step S124, perform backpropagation, calculate a second gradient, update parameters of the general model based on the second gradient, and dynamically adjust a learning rate to avoid overfitting.

A calculation expression for calculating the second loss is as follows:

$${L}_{finetune} = {𝔼}_{p , {a}_{< i}} [ - {\sum }_{i = 1}^{{N}_{a}} log P ( {a}_{i} \vert p , {a}_{< i} ) ] ,$$

where p is an input language prompt, α_{<i} is an action sequence generated before a step i, and N_{α} is a length of the action sequence.
S14. Construct a lightweight and scalable specialized model based on a diffusion model DiT, where the specialized model is a multimodal conditional action denoising model. Specifically, the specialized model includes: a lightweight point cloud visual encoder (PointNet++) and an action generator, where the action generator includes: a causal self-attention layer for processing a time-series action, a cross-modal attention layer for fusing a point cloud feature and an output feature of the general model, a feedforward network for non-linear feature transformation, and a positional encoder for maintaining sequence consistency of time series.
S15. Training of the specialized model.
S151. Acquire a point cloud dataset and robot operation data at a corresponding time, where the point cloud dataset includes point cloud data, robot state proprioception data, and robot action data, and extract the point cloud feature using the lightweight point cloud visual encoder based on the point cloud dataset.
S152. Output an action sequence and a task latent feature using a fine-tuned general model based on the robot operation data at the corresponding time.
S153. Train the specialized model based on the point cloud feature, the action sequence, and the task latent feature, calculate a loss in a training process, and perform backpropagation, calculate a gradient, and update parameters of the specialized model based on the gradient, with an expression for calculating the loss is:

$${L}_{spec} = {𝔼}_{t , c , {a}_{0} , ϵ} [ {‖ ϵ - {π}_{θ} ( \sqrt{{a}_{t}} {a}_{0} + \sqrt{1 - {a}_{t}} ϵ , c , t ) ‖}^{2} ]$$

where π_{θ} is the specialized model; α₀ is a real action; ϵ is Gaussian noise; tis a time step; c is a conditional input, including the action sequence and the task latent feature from the fine-tuned general model and the point cloud feature.
S2. Output the action sequence and the task latent feature.
S21. Adjust a size of the RGB image at a time t₁ to a preset size, such as 224×224, perform normalization, and then extract the visual feature using the visual encoder; and extract the language feature, i.e., a semantic embedding, using the large model based on a task instruction at the time t₁, i.e., a natural language task instruction.
S22. Project the visual feature and the language feature into a unified latent space to generate a task latent feature at the time t₁.
S23. Generate a discretized action sequence through an autoregressive mechanism according to a time step using the general model based on the visual feature and the language feature, with an expression thereof:

$${a}_{{t}_{1}} = {g}_{ϕ} ( {a}_{< {t}_{1}} , c ) ,$$

where αₜ_{₁} represents the action sequence at the time t₁, act, represents an action sequence before the time t₁, c represents the visual feature and the language feature, and g_{φ}(⋅) represents processing by the general model.
S3. Output continuous robot actions.
S31. Extract a real-time point cloud perception feature using the lightweight point cloud visual encoder based on the real-time point cloud perception data from the time t₁ to the time tₙ.
S32. Input a real-time point cloud perception feature at each time with the action sequence and the task latent feature at the time t₁, respectively, into a shared latent space for alignment and fusion, and generate an action at the corresponding time using a diffusion denoising mechanism, with an expression thereof:

$${a}_{{t}_{i}} = {π}_{θ} ( {a}_{{t}_{i}} + ϵ , {c}_{{t}_{i}}^{′} ) ,$$

where αₜ_{ᵢ} represents an action at the time tᵢ and i∈[1, n], ϵ represents Gaussian noise, and cₜ_{ᵢ} represents an alignment and fusion result of a real-time point cloud perception feature at the time tᵢ and the action sequence and the task latent feature at the time t₁.

Moreover, in steps S2 and S3, a fixed window mechanism is adopted for asynchronous collaboration, specifically as follows:
A1. Acquire a task instruction and real-time visual information at a current time t₁, and output an action sequence and a task latent feature at the time t₁ using the general model.
A2. Acquire real-time point cloud perception data from the time t₁ to a time t₈, and output continuous actions from the time t₁ to the time t₈ using the specialized model based on the action sequence and the task latent feature at the time t₁.
A3. When the general model updates and outputs the action sequence and the task latent feature, the specialized model performs step A2 using an updated and output action sequence and task latent feature.
A4. Repeat steps A1 to A3 until a complete robot action is generated.

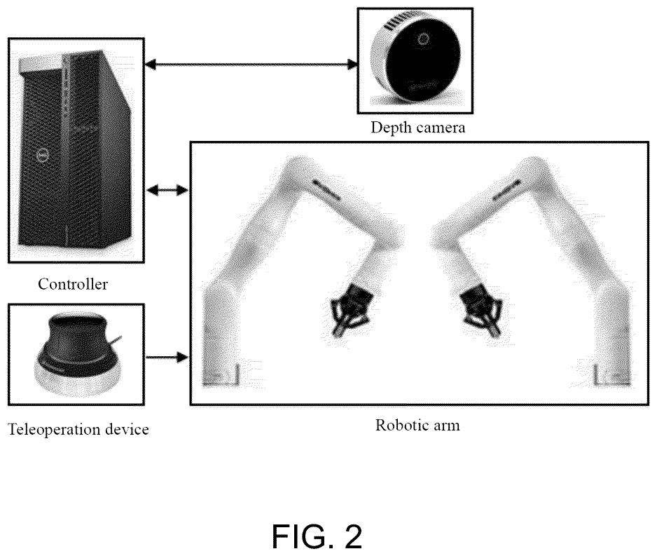

This embodiment further provides a robot action generation system combining general and specialized models for implementing the above method. A hardware framework thereof is shown in FIG. 2, including a controller, a teleoperation device, a depth camera, and a robotic arm. It can be clearly understood by those skilled in the art that, for the convenience and conciseness of description, for the described specific working process, reference may be made to a corresponding process in the above method embodiment, which is not repeated herein.

The above descriptions are only specific implementations of the present invention, but the scope of protection of the present invention is not limited thereto. Any of those skilled in the art can easily think of various equivalent modifications or substitutions within the technical scope of the present invention, and these modifications or substitutions shall all be included within the scope of protection of the present invention. Therefore, the scope of protection of the present invention shall be determined based on the scope of protection of the claims.

What is claimed is:

1. A robot action generation method combining general and specialized models, comprising:
constructing the general model and the specialized model, pre-training the general model, performing parameter fine-tuning on a pre-trained general model, and training the specialized model based on a fine-tuned general model;
acquiring a task instruction and real-time visual information, inputting the task instruction and the real-time visual information into the fine-tuned general model, and outputting an action sequence and a task latent feature; and
acquiring real-time point cloud perception data, and inputting the real-time point cloud perception data, together with the action sequence and the task latent feature, into a trained specialized model, and outputting continuous robot actions.

2. The robot action generation method combining general and specialized models according to claim 1, wherein the general model is constructed based on a vision-language large model.

3. The robot action generation method combining general and specialized models according to claim 1, wherein the specialized model is constructed based on a lightweight and scalable diffusion model.

4. The robot action generation method combining general and specialized models according to claim 1, wherein a step of pre-training the general model comprises:
acquiring robot operation data, wherein the robot operation data comprises a language instruction, image data, and robot action data;
extracting a language feature and a visual feature using the general model based on the language instruction and the image data, and aligning the language feature and the visual feature; and
iteratively performing following steps until pre-training is completed:
inputting an aligned language feature and visual feature into the general model, outputting a first discretized action, and performing decoding processing on the first discretized action; and
calculating a first loss based on a decoded first discretized action and the robot action data, and performing backpropagation, calculating a first gradient, and updating parameters of the general model based on the first gradient.

5. The robot action generation method combining general and specialized models according to claim 4, wherein a method for fine-tuning the general model comprises:
acquiring robot operation data under a specific task, and acquiring parameters of the pre-trained general model as initial parameters;
determining a fine-tuning range for parameters related to visual feature extraction, language feature extraction, and action decoding in the initial parameters, and freezing other parameters in the initial parameters;
inputting the robot operation data under the specific task into the general model, and outputting a second discretized action; and
calculating a second loss based on the second discretized action and robot action data in the robot operation data under the specific task, and performing backpropagation, calculating a second gradient, and updating parameters of the general model based on the second gradient.

6. The robot action generation method combining general and specialized models according to claim 5, wherein a step of training the specialized model comprises:
acquiring a point cloud dataset and robot operation data at a corresponding time, wherein the point cloud dataset comprises point cloud data, robot state proprioception data, and robot action data;
outputting the action sequence and the task latent feature using the fine-tuned general model based on the robot operation data at the corresponding time; and
training the specialized model based on the point cloud dataset, the action sequence, and the task latent feature, calculating a loss in a training process, and performing backpropagation, calculating a gradient, and updating parameters of the specialized model based on the gradient.

7. The robot action generation method combining general and specialized models according to claim 1, wherein the general model and the specialized model collaborate asynchronously, and a method for asynchronous collaboration is:
acquiring a task instruction and real-time visual information at a current time t₁, and outputting an action sequence and a task latent feature at the time t₁ using the general model; and
acquiring real-time point cloud perception data from the time t₁ to a time tₙ, and outputting continuous actions from the time t₁ to the time tₙ using the specialized model based on the action sequence and the task latent feature at the time t₁.

8. The robot action generation method combining general and specialized models according to claim 7, wherein a method for the outputting the action sequence and the task latent feature at the time t₁ is:
extracting a visual feature using the general model based on the visual information at the time t₁, and extracting a language feature using the general model based on the task instruction at the time t₁;
projecting the visual feature and the language feature into a unified latent space to generate a task latent feature at the time t₁; and
generating a discretized action sequence according to a time step using the general model based on the visual feature and the language feature, with an expression thereof:
$${a}_{{t}_{1}} = {g}_{ϕ} ( {a}_{< {t}_{1}} , c ) ,$$
wherein αₜ_{₁} represents the action sequence at the time t₁, act represents an action sequence before the time t₁, c represents the visual feature and the language feature, and g_{φ}(⋅) represents processing by the general model.

9. The robot action generation method combining general and specialized models according to claim 7, wherein a method for outputting the continuous actions from the time t₁ to the time tₙ comprises:
extracting a real-time point cloud perception feature based on the real-time point cloud perception data from the time t₁ to the time tₙ; and
aligning and fusing a real-time point cloud perception feature at each time with the action sequence and the task latent feature at the time t₁, respectively, and generating an action at the corresponding time using a diffusion denoising mechanism, with an expression thereof:
$${a}_{{t}_{i}} = {π}_{θ} ( {a}_{{t}_{i}} + ϵ , {c}_{{t}_{i}}^{′} ) ,$$
wherein αₜ_{ᵢ} represents an action at the time tᵢ and i∈[1, n], e represents Gaussian noise, and cₜ_{ᵢ} represents an alignment and fusion result of a real-time point cloud perception feature at the time tᵢ and the action sequence and the task latent feature at the time t₁.

10. A robot action generation system combining general and specialized models for implementing the method according to claim 1.
